(19) United States
(12) Patent Application Publication
(10) Pub. No.: US 2020/0370442 A1
(43) Pub. Date: Nov. 26, 2020

(54) SEALING DEVICE

(71) Applicant: Rolls-Royce Deutschland Ltd & Co KG, Blankenfelde-Mahlow (DE)

(72) Inventor: Hamish SWEIDAN, Berlin (DE)

(21) Appl. No.: 16/419,631

(22) Filed: May 22, 2019

(51) Int. Cl. F01D 11/00; F01D 5/02

(52) U.S. Cl. CPC F01D 11/006; F01D 5/025; F05D 2240/24; F05D 2240/55; F05D 2220/32

(57) ABSTRACT

A sealing device including a retaining plate arranged in contact with an axial face of the rotor disc such that the retaining plate covers a gap between one of the retention grooves and the corresponding blade secured therein, along the axial direction; and a horn-shaped member protruding from the retaining plate and extending inside of an extrusion in the blade, the horn-shaped member having a first section seated against a complimentary surface inside the extrusion in the blade, wherein a center of gravity of the sealing device lies proximal to the first section of the horn-shaped member to cause the retaining plate to be pulled against the axial face of the rotor disc when the rotor disc is rotating, in order to secure the sealing device with the rotor disc.

### TECHNICAL FIELD

The present disclosure relates generally to gas turbine engines; and more specifically, to a sealing device for sealing a gap between a rotor disc and a corresponding blade secured in a retention groove of the rotor disc in a gas turbine engine.

### BACKGROUND

Gas turbine systems are widely utilized in fields such as power generation. A conventional gas turbine system includes a compressor, a combustor, and a turbine. During operation of the gas turbine system, various components in the system are subjected to high temperature conditions, which can cause the components to fail. However, higher temperature conditions are sometimes desirable, as such conditions generally result in increased performance, efficiency, and power output of the gas turbine system. Therefore, the components that are subjected to high temperature must be cooled to allow the gas turbine system to operate at increased temperatures.

Typically, gas turbine engines include a rotor disc having a row of blades that are arranged along a periphery of the rotor disc. These blades are in the hot gas path and thus need to be cooled. For this purpose, cooling air is expelled around the blades to lower their temperature. However, there exists a gap between the blades and the rotor disc that can cause the cooling air to leak, and the hot gases to enter the gaps, thereby leading to possible failure of the blades.

Conventionally, various strategies are known in the art for preventing leakage from the gaps between the blades and the rotor disc. One conventional strategy is to minimize the size of such gaps during manufacture. However, minimizing the gaps' size is not always achievable, as the interaction of the rotor blades with the rotor disc with small gaps may lead to higher wear and tear of the blades and the rotor disc or manufacturing tolerances might not allow for smaller gaps. Furthermore, other prior-art arrangements may utilize lock plates, seal plates, rim cover plates, full face cover plates, or combinations of those, mounted on the rotor disc for sealing the gap between the rotor disc and the blades. However, such arrangements require that the rotor disc must be specially manufactured to include features for carrying such plates, which may require a lot of design changes and turn out to be expensive. Further, such plates potentially have low life, and use of any of such plates add weight, thus limiting the engine life. Additionally, even though such plates are pushed against the disc on assembly, during engine running, complex thermal effects during transient maneuvers can cause warping, that can cause the plate to lift off, losing the sealing function.

Therefore, in light of the foregoing discussion, there exists a need to overcome the aforementioned drawbacks associated with conventional sealing devices. In particular, there is a need to provide a coupling arrangement which can be employed for sealing the gap between the rotor disc and the blades with minimal modification to the existing design of the gas turbine engines.

### SUMMARY

The present disclosure seeks to provide a sealing device for a rotor of a gas turbine engine. The present disclosure seeks to provide a solution to the existing problem of leakage of cooling air that is intended for cooling of the blades, to prevent overheating of the blades of the gas turbine and eventually a failure of one or more components of the gas turbine engine. Furthermore, the present disclosure also seeks to provide a solution to unnecessary wastage of energy due to leakage of cooling air, thereby improving efficiency of operation of the gas turbine engine. An aim of the present disclosure is to provide a solution that overcomes at least partially the problems encountered in prior-art, and provides an efficient and a cost-effective sealing device that can be easily and readily employed for sealing a gap between a retention groove and a corresponding blade secured therein of a gas turbine engine or the like, thereby increasing the power output and hence the efficiency of the gas turbine engine.

Embodiments of the present disclosure provide a sealing device for a rotor of a gas turbine engine, the rotor comprising a rotor disc with an annular array of retention grooves and a plurality of radially extending blades secured in the retention grooves, the sealing device comprising:
a retaining plate arranged in contact with an axial face of the rotor disc such that the retaining plate covers a gap between the rotor disc and one of the blades secured in one of the retention grooves therein; and
a horn-shaped member protruding from the retaining plate and extending inside of an extrusion in the blade, the horn-shaped member having a first section seated against a complimentary surface inside the extrusion in the blade,

wherein a center of gravity of the sealing device lies proximal to the first section of the horn-shaped member to cause the retaining plate to be pulled against the axial face of the rotor disc when the rotor disc is rotating, to secure the sealing device with the rotor disc.

Embodiments of the present disclosure substantially eliminate or at least partially address the aforementioned problems in the prior-art, and provide an efficient and cost-effective sealing device that effectively seals the gap between a rotor disc and a corresponding blade secured in the retention groove of the rotor disc. The sealing device as disclosed herein is light-weight in comparison to conventional gap sealing arrangements that are bulky and add an extra weight to the turbine engines. Furthermore, the sealing device can be fitted into the existing blades by simply removing a portion of the blade to define an extrusion. Henceforth, no further modification in the existing designs of the blades or the rotor disc is needed to employ the disclosed sealing device.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a sectional view of a typical gas turbine engine;

FIG. 2 is an illustration of a planar view of a portion of a rotor disc of the gas turbine engine with one or more blades secured therein depicting gaps there between, in accordance with prior-art;

FIG. 3A is an illustration of a perspective view of a sealing device having a J-shaped profile, in accordance with a first embodiment of the present disclosure;

FIG. 3B is an illustration of a perspective view of a sealing device having a L-shaped profile, in accordance with a second embodiment of the present disclosure;

FIG. 4 is an illustration of a planar view of a portion of a rotor disc incorporating the sealing device for covering the gap (as depicted in FIG. 2), in accordance with various embodiments of the present disclosure;

FIG. 5A is an illustration of a sectional planar side view of a portion of a rotor disc incorporating the sealing device of FIG. 3A, in accordance with the first embodiment of the present disclosure;

FIG. 5B is an illustration of a sectional perspective wireframe view of a portion of a rotor disc incorporating the sealing device of FIG. 3A, in accordance with the first embodiment of the present disclosure;

FIG. 6A is an illustration of a sectional planar side view of a portion of a rotor disc incorporating the sealing device of FIG. 3B, in accordance with the second embodiment of the present disclosure; and

FIG. 6B is an illustration of a sectional perspective wireframe view of a portion of a rotor disc incorporating the sealing device of FIG. 3B, in accordance with the second embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Embodiments of the present disclosure provide a sealing device for a rotor of a gas turbine engine, the rotor comprising a rotor disc with an annular array of retention grooves and a plurality of radially extending blades secured in the retention grooves, the sealing device comprising:
a retaining plate arranged in contact with an axial face of the rotor disc such that the retaining plate covers a gap between the rotor disc and one of the blades secured in one of the retention grooves therein; and
a horn-shaped member protruding from the retaining plate and extending inside of an extrusion in the blade, the horn-shaped member having a first section seated against a complimentary surface inside the extrusion in the blade,
   wherein a center of gravity of the sealing device lies proximal to the first section of the horn-shaped member to cause the retaining plate to be pulled against the axial face of the rotor disc when the rotor disc is rotating, to secure the sealing device with the rotor disc.

The present disclosure relates to a sealing device for a gas turbine engine. The term “gas turbine engine” as used herein generally relates to a system comprising a combustor, a compressor, and a turbine. The compressor and the turbine may be coupled by a shaft or a plurality of shafts. The turbine may include a plurality of turbine stages, for example, a first stage turbine, a second stage turbine or a third stage turbine and a fourth stage turbine as known in the art. A rotor disc or a plurality of rotor discs are generally coupled to the shaft and the rotor disc is operable to rotate about the shaft as hot gases flow through the turbine stages. It will be appreciated that the present disclosure is not limited to a gas turbine system, but may also be suitable for a steam turbine system or any other turbine system configured to be operated under high pressures and high temperatures.

Generally, the rotor disc comprises an annular array of retention grooves and a plurality of radially extending blades secured in the retention grooves. Herein, the term “rotor disc” generally refers to an annular disc with well-defined retention grooves arranged circumferentially in an alternate manner in the periphery of the rotor disc. The retention grooves are designed in a manner so as to securely accommodate one blade per retention groove. Optionally, a retention groove may accommodate two blades per retention groove, as in case of a twin shank blade. In an example, the rotor disc may have a firtree configuration. Herein, the term “blades” refers to turbine blades, or stator blades that are subjected to high temperatures. Each of the blades comprises an airfoil having a leading edge and a trailing edge, a platform and a shank. The airfoil extends radially outward from the platform, and the shank extends radially inward from the platform. Further, the blade may comprise a dovetail, extending radially inwards from the shank. The dovetail acts an interface between the rotor disc and the blade. In an example, the dovetail may comprise a pressure side surface, a suction side surface, an upstream surface, a downstream surface and a base surface. When the gas turbine engine is in operation, hot gases flow through the turbine, the rotor disc and the blades, raising the temperature of the blades which may cause deformation of the blades, and eventual failure of the gas turbine engine. In order to control the overheating of the blades, sometimes, the blades comprise an internal cooling system, wherein pressurized cooling air is inserted into inlets of the dovetails, through passages inside walls of the blades and finally escape through small holes in the airfoil of the blade, leading to cooling of the blade.

The sealing device of the present disclosure is provided for sealing a gap between the rotor disk and the blade secured therein. The gap exists at the interface between the blades and the rotor disc, also known as firtree or blade slot or dovetail. More specifically, the gap exists between the periphery of the dovetail and the periphery of the retention groove. The gap may also be referred as a bucket groove. The cooling air that is intended to enter the cooling system of the blades through passages in the base surface of the dovetail, may escape via such gap, which is undesirable. The sealing device as disclosed herein seals the bucket groove, thus preventing such undesirable leakage of the cooling air.

According to an embodiment, the sealing device comprises a retaining plate arranged in contact with an axial face of the rotor disc such that the retaining plate covers the gap between the rotor disc and one of the blades secured in one of the retention grooves therein. Herein, the “axial face” refers to a face of the rotor disc along a central axis of the rotor disc. The central axis is the longitudinal axis of the rotor disc about which the rotor disc is rotated. It will be appreciated that the rotor disc comprises two axial faces, an upstream axial face and a downstream axial face. In an example, the retaining plate is arranged to be in contact with a portion of the upstream axial face of the rotor disc and a portion of the upstream surface of the blade so as to cover the gap therebetween. In another example, the retaining plate is arranged to be in contact with a portion of the downstream axial face of the rotor disc and a portion of the downstream surface of the blade so as to cover the gap therebetween In yet another example, two sealing devices may be employed, with retaining plate of one of the two sealing devices arranged to cover the gap between the upstream axial face and the upstream surface of the blade, and with retaining plate of other of the two sealing devices arranged to cover the gap between the downstream axial face and the downstream surface of the blade.

The retaining plate may include an upper surface and a lower surface, such that a portion of the lower surface lies adjacent to a portion of the axial face of the rotor disc and the blade, such that the retaining plate covers the gap therebetween. The retaining plate may be of any suitable size or shape to cover the gap between the blade and the rotor disc. In an example, the retaining plate may partially cover the gap. In another example, the cover plate may be extended to cover the entire gap corresponding to a retention groove. Optionally, the retaining plate is rectangular in shape having an upper end and a lower end and two lateral ends. The rectangular plate has a width that extends between the two lateral ends. The width of the rectangular plate is at least larger than a width of a lower end of the corresponding retention groove, such that the width of the rectangular plate efficiently covers the gap between the blade and the corresponding retention groove. Furthermore, optionally, the retaining plate is trapezoidal in shape having an upper end and a lower end, such that the lower end is shorter than the upper end, thereby forming a trapezoid, the width of which increases in a radially outward direction. The rate of increase in width of the trapezoid may be proportional to a rate of increase in width of the retention groove.

According to an embodiment, the sealing device comprises a horn-shaped member protruding from the retaining plate and extending inside of an extrusion in the blade, the horn-shaped member having a first section seated against a complimentary surface inside the extrusion in the blade. The horn-shaped member protrudes from an inner surface of the retaining plate. Preferably, the horn-shaped member protrudes from a center of the inner surface of the retaining plate. Further, the horn-shaped member is configured to be accommodated inside the extrusion of the blade. Herein, the term “extrusion” refers to a recess or a channel in the blade, defined to receive and retain the horn-shaped member. In particular, the extrusion is extending from a lower end of the blade radially upward. The extrusion may be a cutaway portion in the blade.

Optionally, the extrusion includes a defined ramp face towards lower end thereof, and a defined channel extending radially upwards from the ramp face in the blade. The channel of the extrusion extends along a radial length of the blade. Notably, the blade may comprise a single extrusion or a pair of extrusion therein, depending upon the number of sealing devices to be engaged therewith. In an example, the blade may comprise a single extrusion proximal to the upstream surface thereof. In such a case, the sealing plate engages with the blade to cover the gap between the upstream axial face of the rotor disc and the upstream surface of the blade. In another example, the blade may comprise a single extrusion proximal to the downstream surface thereof. In such a case, the sealing plate engages with the blade to cover the gap between the downstream axial face of the rotor disc and the downstream surface of the blade. In yet another example, the blade may comprise a pair of extrusions, such that a first extrusion is proximal to the upstream surface thereof and a second extrusion is proximal to the downstream surface thereof. In such a case, two sealing plates, including a first sealing plate and a second sealing plate, are engaged with the blade. Herein, the first sealing plate engages with the blade to cover the gap between the upstream axial face of the rotor disc and the upstream surface of the blade; and the second sealing plate engages with the blade to cover the gap between the downstream axial face of the rotor disc and the downstream surface of the blade. Optionally, in one or more embodiments, the extrusion may be any one of the holes or inlets (as a part of the internal cooling system) present in the blade, provided to facilitate an in-flow of the cooling air through these inlets. In an example, the horn-shaped member of the sealing device may be inserted in any one of the inlets to seal the gap. However, it will be appreciated that to effectively seal the gap, the sealing device is to be engaged with an inlet proximal to the upstream surface of the dovetail, or an inlet proximal to the downstream surface of the dovetail, or a combination thereof. It will be appreciated that a shape and size of the extrusion are dimensioned to be similar to that of a shape and size of the horn-shaped member. Notably, the dimensions of the extrusion should be such so as to facilitate an insertion of the horn-shaped member into the extrusion without any difficulty. However, at the same time the dimensions should be such so as restrict a fallout of the horn-shaped member from the extrusion.

The horn-shaped member comprises a first section. The first section extends from the retaining plate in a direction complimentary to the ramp face of the extrusion. In particular, the first section may be in the shape of a ramp that extends outwards from the retaining plate generally at an acute angle with respect to a plane of the retaining plate. Notably, the first section is designed such that a surface of the first section is seated against the complimentary surface inside the extrusion in the blade. Herein, the complimentary surface inside the extrusion of the blade is the ramp face so as to effectively engage with the first section to accommodate the horn-shaped member inside the extrusion.

Optionally, in one or more embodiments the horn-shaped member comprises a connecting section to provide an interface between the retaining plate and the first section. In an example, the connecting section may generally be cuboidal shaped portion having a first end and a second end. The first end is in contact with the retaining plate, whereas the second end is in contact with the first section. The connecting section extends from the retaining plate, generally, along an axial direction of the rotor disc.

Optionally, the horn-shaped member further comprises a second section extending from the first section in a radial direction of the rotor disc, inside the extrusion in the blade. The second section is extended in a radially outward direction, such that the second section is generally parallel to the plane of the retaining plate. The second section engages with the channel of the extrusion. Notably, the shape and size of the second section are dimensioned to be complimentary with shape and size of the channel of the extrusion. In particular, the first section of the horn-shaped member is engaged with the ramp face of the extrusion and the second section of the horn-shaped member is engaged with the channel of the extrusion, such that the sealing device is effectively engaged with the blade to prevent a disengagement of the sealing device under gravitational force.

Optionally, the horn-shaped member has a L-shaped profile with the first section extending flat at an acute angle with respect to the retaining plate. That is, the first section (or the ramp section) is designed to be at an acute angle with respect to the retaining plate. It will be appreciated that the acute angle of the first section corresponds to an angle of the entrance in the extrusion of the blade, as discussed above. Further, the second section extends in a radially outward manner from the first section, to impart the L-shaped profile to the horn-shaped member.

Optionally, the horn-shaped member has a J-shaped profile with the first section extending in a curved manner. That is, the first section is curved corresponding to an inner surface of the extrusion. Further, the second section extends radially outwards from the first section, to impart the J-shaped profile to the horn-shaped member.

According to an embodiment, a center of gravity of the sealing device lies proximal to the first section of the horn-shaped member to cause the retaining plate to be pulled against the axial face of the rotor disc when the rotor disc is rotating, to secure the sealing device with the rotor disc. When in operation, the rotor disc exerts a centrifugal force in a radially outward direction with respect to the central axis of the rotor disc. Herein, the term “centrifugal force” refers to an inertial force that is acting on each of the blades, in particular on the first section of the horn-shaped member in the sealing device, and in a direction radially outwards from the central axis of the rotor disc. Additionally, the term “center of gravity” refers to an imaginary point that lies near the first section and wherein a weight of the entire sealing device is concentrated. It will be appreciated that the sealing device is an asymmetric structure, and therefore dimensions and weight of the sections, such as the retaining plate and the horn-shaped member plays an important role in a position of the center of gravity of the sealing device. Therefore, the sealing device is designed in a way such that the center of gravity of the sealing device lies proximal to the first section. As the centrifugal force is exerted on the sealing device at the center of gravity (i.e. in proximity to the first section of the horn-shaped member), the centrifugal force causes the retaining plate to be pulled against the axial face of the rotor disc. For example, the centrifugal force causes the retaining plate to be pulled against the downstream surfaces of the blade and the rotor disc, in order to secure the sealing device with the rotor disc and effectively sealing the gap between the rotor disc and the blade.

Optionally, the sealing device further comprises a retaining member protruding from the retaining plate and extending inside the gap. The retaining member protrudes from the inner surface of the retaining plate. Preferably, the retaining member extends from a position proximal to the lower end of the retaining plate. The retaining member extends in a direction, generally, perpendicular to the retaining plate. It will be appreciated that the retaining member is extending in the axial direction of the rotor disc. As mentioned, the retaining member extends inside the gap (as part of the retention groove) between the rotor disc and the corresponding blade secured therein. In particular, the retaining member is located between the lower end of the blade and the lower end of the retention groove. The retaining member advantageously prevents the sealing device from falling out of the gap due to pivoting of the retaining plate because of gravity, by pushing against any one of the lower end of the blade and the lower end of the retention groove, when the rotor disc is not in rotation.

Optionally, the sealing device further comprises a retaining ring encircling the retaining plate and the blade to secure the retaining plate and the blade together. It may be appreciated that the retaining ring may be an elastic member or the like that could be placed around the retaining plate and the blade together to press the two against each other and prevent any axial movement therebetween.

Optionally, the present disclosure further relates to a method of assembling the rotor of the gas turbine engine. The rotor comprises a rotor disc with an annular array of retention grooves and a plurality of radially extending blades secured in the retention grooves. The method comprises providing a sealing device comprising a retaining plate and a horn-shaped member protruding from the retaining plate. Further, the method comprises accommodating the horn-shaped member of the sealing device inside of an extrusion in the blade such that a first section of the horn-shaped member is seated against a complimentary surface inside the extrusion in the blade. Further, the method comprises arranging the blade, along with the sealing device, inside the retention groove such that the retaining plate is disposed in contact with an axial face of the rotor disc and covers a gap between the rotor disc and one of the blades secured in one of the retention grooves therein, with a center of gravity of the sealing device lying proximal to the first section of the horn-shaped member to cause the retaining plate to be pulled against the axial face of the rotor disc when the rotor disc is rotating, to secure the sealing device with the rotor disc.

### DETAILED DESCRIPTION OF THE DRAWINGS

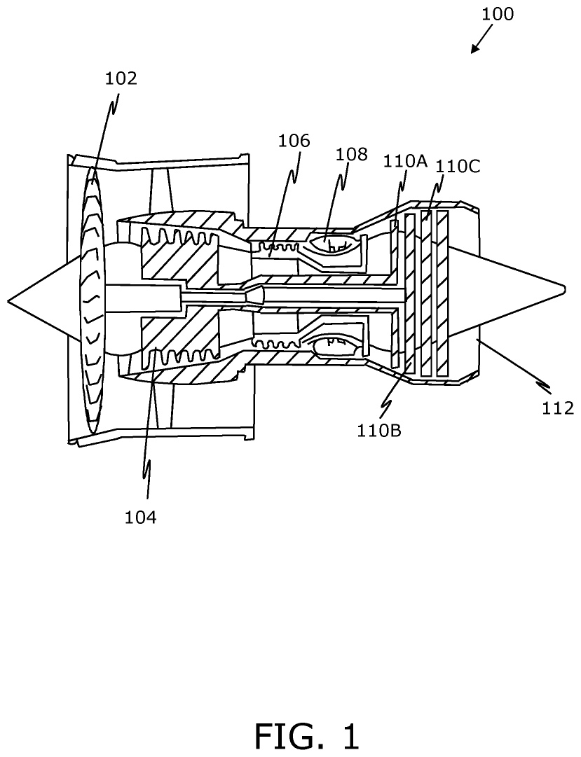

Referring to FIG. 1, illustrated is a schematic representation of a sectional view of a gas turbine engine 100. As shown, the gas turbine engine 100 comprises a ducted fan 102, intermediate pressure compressor 104, high pressure compressor 106, combustion equipment 108; high, intermediate and low-pressure turbines 110A, 1108 and 110C respectively and an exhaust nozzle 112. Herein, the engine 100 functions in the usual manner in which air accelerated by the fan 102 and is pressurized by passing through the compressors 104 and 106, and eventually mixed with combustion fluid to form hot combustion products that drive the high, intermediate and low-pressure turbines 110A, 1108 and 110C. Herein, each of the high, intermediate and low-pressure turbines 110A, 1108 and 110C comprise a rotor disc (not shown) with a plurality of blades extending radially from a periphery of the rotor disc in the turbines. The blades are subjected to extreme working conditions such as high temperatures and high pressures. To prevent degradation of the blades, the turbines 110A, 1108 and 110C are equipped with a cooling system to provide cooling air to decrease the temperature of the blades. However, the cooling air that is intended to enter the cooling system of the blades is prone to leakages from gap between the rotor disc and the corresponding blades. Notably, the embodiments of the present disclosure are concerned with a sealing device to seal the gap between the rotor disc and the corresponding blades.

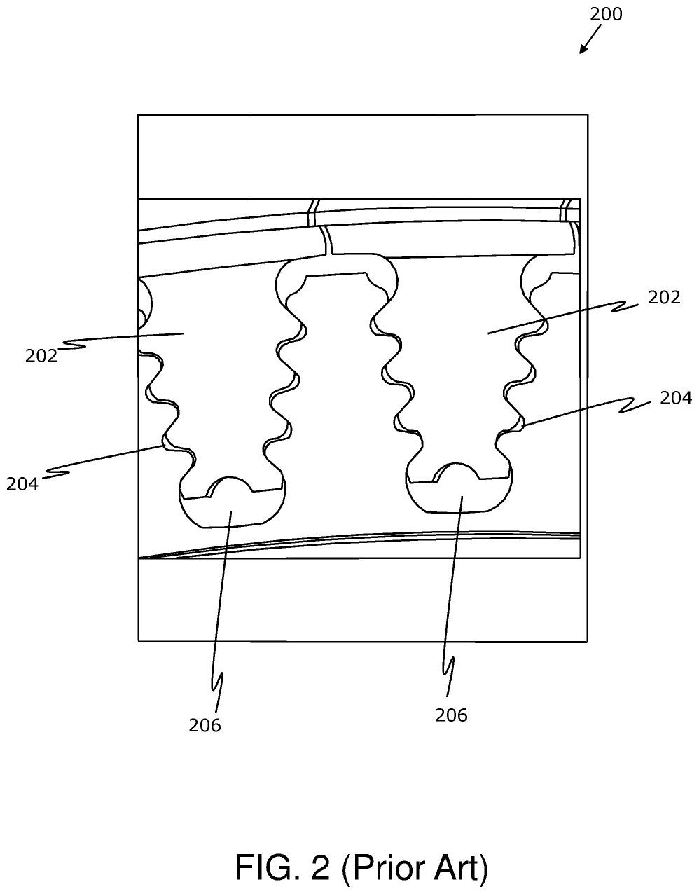

Referring to FIG. 2, illustrated is a schematic representation of a portion of a rotor disc 200 with one or more blades 202 secured therein, as known in the art. As shown, the portion of the rotor disc 200 comprises retention grooves 204. The blades 202 are arranged in the retention grooves 204 that extend radially outwards from an axis of the rotor disc 200. As shown, there exists a gap 206 between an interface between the blades 202 and the retention grooves 204. It will be appreciated that only a portion of the rotor disc 200 is illustrated. However, the rotor disc 200 is an annular disc with a plurality of retention grooves 204 on an outer periphery of the rotor disc 200, and a plurality of radially extending blades 202 arranged in the retention grooves 204 as may be contemplated by a person skilled in the art.

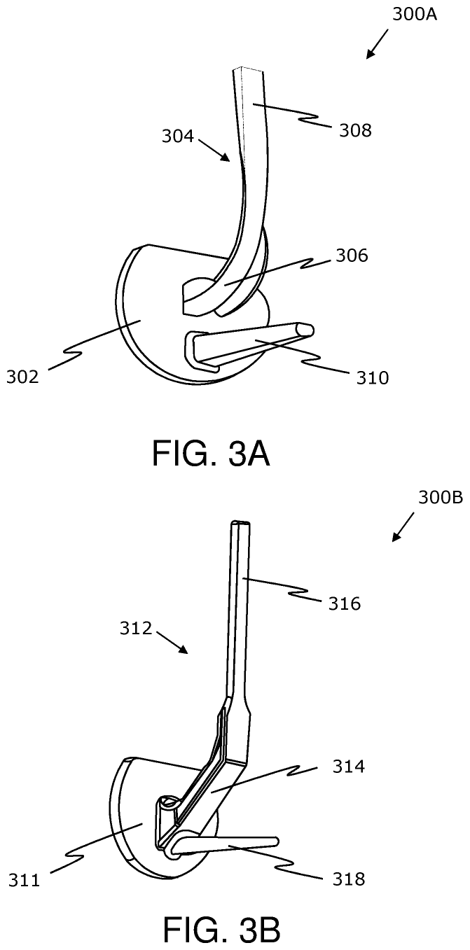

Referring to FIG. 3A, illustrated is a schematic representation of a sealing device 300A, in accordance with a first embodiment of the present disclosure. As shown, the sealing device 300A has a J-shaped profile. The sealing device 300A comprises a retaining plate 302 to be arranged in contact with an axial face of a rotor disc (as shown in FIG. 2) such that the retaining plate 302 covers a gap between one of the retention grooves and the corresponding blade secured therein. Further, the sealing device 300A comprises a horn-shaped member 304 protruding from the retaining plate 302. The horn-shaped member 304 includes a first section 306 and a second section 308. Herein, the first section 306 is curved in shape and extends away from the retaining plate 302. Furthermore, the second section 308 extends outwardly from the first section 306 (in a radial direction of the rotor disc). Optionally, the sealing device 300A comprises a retaining member 310, extending away from the retaining plate 302 (in an axial direction of the rotor disc).

Referring to FIG. 3B, illustrated is a schematic representation of a sealing device 300B, in accordance with a second embodiment of the present disclosure. As shown, the sealing device 300B has a L-shaped profile. The sealing device 300B comprises a retaining plate 311 to be arranged in contact with an axial face of a rotor disc (as shown in FIG. 2) such that the retaining plate 311 covers a gap between one of the retention grooves and the corresponding blade secured therein. Further, the sealing device 300B comprises a horn-shaped member 312 protruding from the retaining plate 311. The horn-shaped member 312 includes a first section 314 and a second section 316. Herein, the first section 314 is a ramp section extending flat at an acute angle with respect to the retaining plate 311. Furthermore, the second section 316 extends outwardly from the first section 314 (in a radial direction of the rotor disc). Optionally, the sealing device 300B comprises a retaining member 318, extending away from the retaining plate 311 in the axial direction.

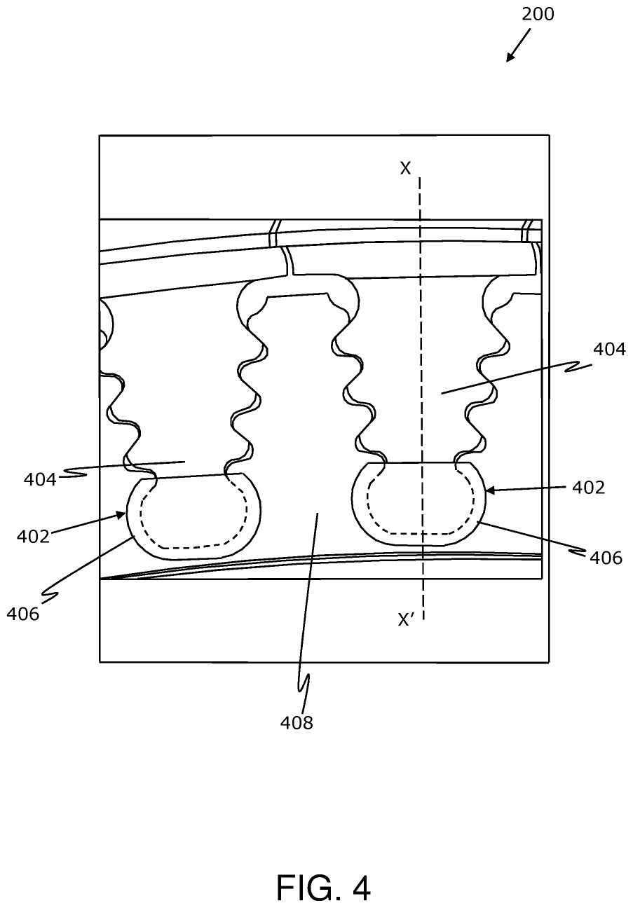

Referring to FIG. 4, illustrated is a schematic representation of an arrangement of FIG. 2 with sealing devices 402 (such as any of the sealing device 300A, 300B of FIGS. 3A, 3B) covering the gaps (i.e. the gaps 206 of FIG. 2, not shown herein), in accordance with an embodiment of the present disclosure. Each of the sealing devices 402 is engaged with each of the blades 404 such that respective retaining plate 406 is in contact with an axial face of the corresponding blade and the rotor disc in order to seal the gap therebetween.

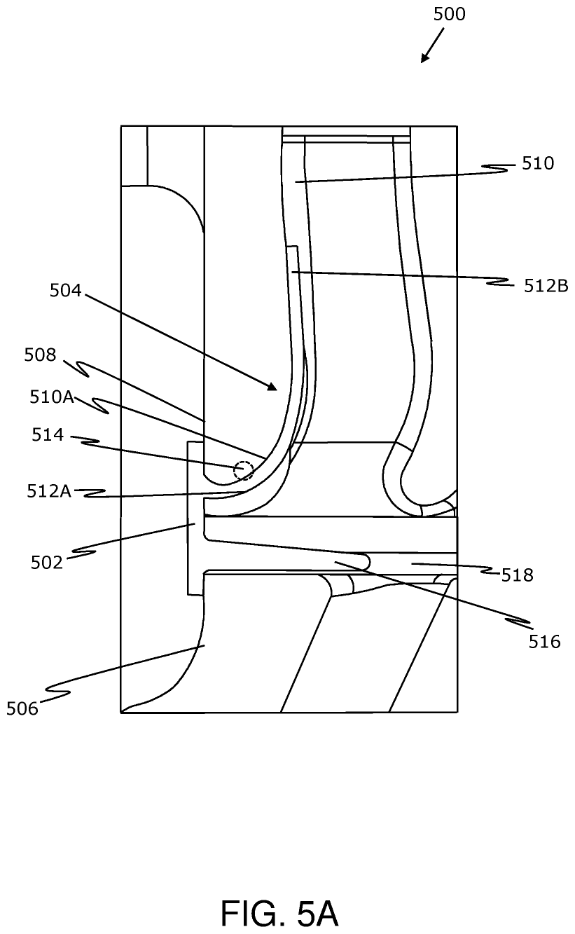

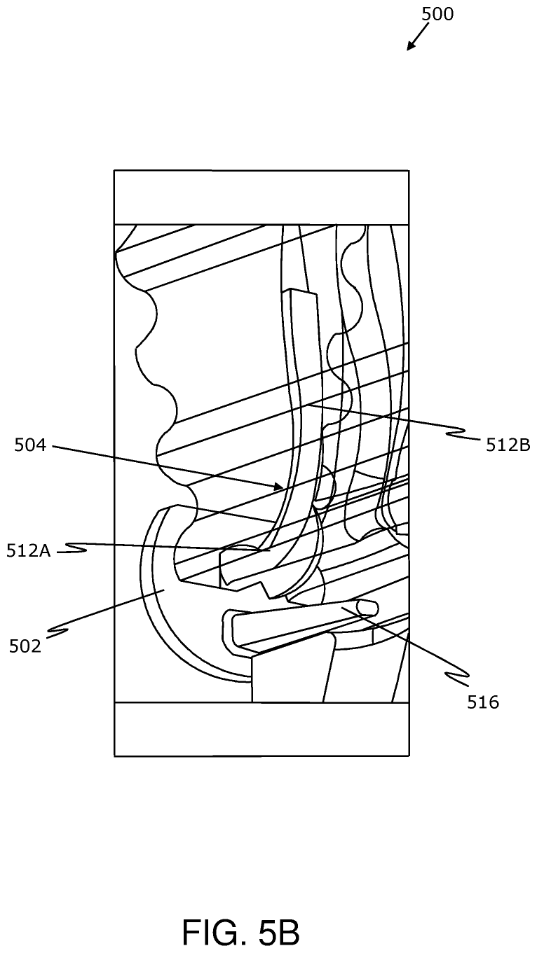

Referring to FIG. 5A, illustrated is a schematic representation of a sectional view of an arrangement of the sealing device 500 along an axis XX′, as shown in FIG. 4, in accordance with the first embodiment of the present disclosure. Further, referring to FIG. 5B, illustrated is a wire frame view of the arrangement of the sealing device 500 as shown in FIG. 5A, in accordance with the first embodiment of the present disclosure. As shown in FIGS. 5A-5B, the sealing device 500 (such as the sealing device 300A of FIG. 3A) has a J-shaped profile. The sealing device 500 comprises a retaining plate 502 and a horn-shaped member 504. As shown, the retaining plate 502 is arranged in contact with an axial face of the rotor disc 506 such that the retaining plate 502 covers a gap 518 in one of the retention grooves between the rotor disc 506 and corresponding blade 508 secured therein. Herein, the horn-shaped member 504 protrudes from the retaining plate 502 in a curved manner and extends inside of an extrusion 510 in the blade 508. As shown, the horn-shaped member 504 includes a first section 512A and a second section 512B. In particular, the first section 512A is seated against a complimentary surface 510A inside the extrusion 510 in the blade 508. The second section 512B extends from the first section 512A in a radially outward direction of the rotor disc 506. Furthermore, as shown, a center of gravity (as shown by a dashed circle and indicated by numeral 514) of the sealing device 500 lies proximal to the first section 512A of the horn-shaped member 504 to cause the retaining plate 502 to be pulled against the axial face of the rotor disc 506 when the rotor disc 506 is rotating, to secure the sealing device 500 with the rotor disc. As shown, the sealing device 500 further comprises a retaining member 516 protruding from the retaining plate 502 and extending inside the gap 518.

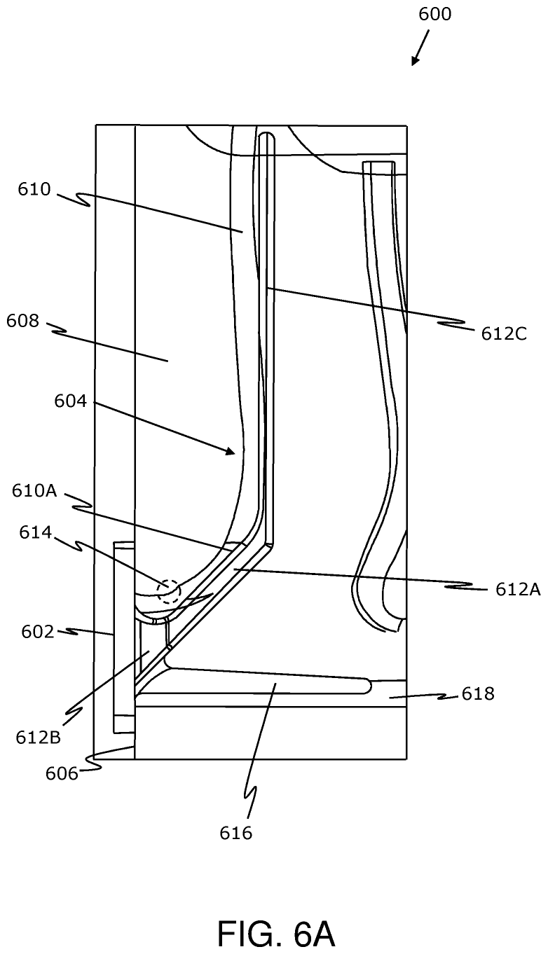

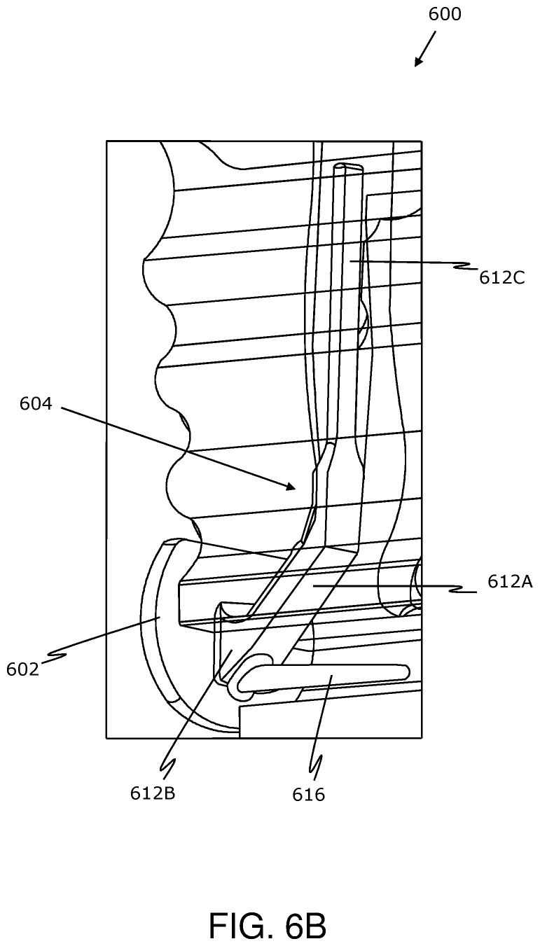

Referring to FIG. 6A, illustrated is a schematic representation of a sectional view of an arrangement of the sealing device 600 along an axis XX′, as shown in FIG. 4, in accordance with a second embodiment of the present disclosure. Further, referring to FIG. 6B, illustrated is a wire frame view of the arrangement of the sealing device 600 as shown in FIG. 6A, in accordance with the second embodiment of the present disclosure. As shown in FIGS. 6A-6B, the sealing device 600 (such as the sealing device 300B of FIG. 3B) has a L-shaped profile. The sealing device 600 comprises a retaining plate 602 and a horn shaped member 604. As shown, the retaining plate 602 is arranged in contact with an axial face of the rotor disc 606 such that the retaining plate 602 covers a gap 618 in one of the retention grooves between the rotor disc 606 and the corresponding blade 608 secured therein. Herein, the horn-shaped member 604 protrudes from the retaining plate 602 and extends inside of an extrusion 610 in the blade 608. As shown, the horn-shaped member 604 includes a first section 612A, a connecting section 612B and a second section 612C. In particular, the first section 612A is seated against a complimentary surface 610A inside the extrusion 610 in the blade 608. The second section 612C extends from the first section 612A in a radially outward direction of the rotor disc 606. Furthermore, as shown, a center of gravity (as shown by a dashed circle and indicated by numeral 614) of the sealing device 600 lies proximal to the first section 612A of the horn-shaped member 604 to cause the retaining plate 602 to be pulled against the axial face of the rotor disc 606 when the rotor disc 606 is rotating, to secure the sealing device 600 with the rotor disc. As shown, the sealing device 600 further comprises a retaining member 616 protruding from the retaining plate 602 and extending inside the gap 618.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A sealing device for a rotor of a gas turbine engine, the rotor comprising a rotor disc with an annular array of retention grooves and a plurality of radially extending blades secured in the retention grooves, the sealing device comprising:
a retaining plate arranged in contact with an axial face of the rotor disc such that the retaining plate covers a gap between the rotor disc and one of the blades secured in one of the retention grooves therein; and
a horn-shaped member protruding from the retaining plate and extending inside of an extrusion in the blade, the horn-shaped member having a first section seated against a complimentary surface inside the extrusion in the blade,
wherein a center of gravity of the sealing device lies proximal to the first section of the horn-shaped member to cause the retaining plate to be pulled against the axial face of the rotor disc when the rotor disc is rotating, to secure the sealing device with the rotor disc.

2. The sealing device of claim 1, wherein the horn-shaped member further comprises a second section extending from the first section in a radial direction of the rotor disc, inside the extrusion in the blade.

3. The sealing device of claim 1, wherein the horn-shaped member has a J-shaped profile with the first section extending in a curved manner.

4. The sealing device of claim 1, wherein the horn-shaped member has a L-shaped profile with the first section extending flat at an acute angle with respect to the retaining plate.

5. The sealing device of claim 1 further comprising a retaining member protruding from the retaining plate and extending inside the gap.
